(19) United States
(12) Patent Application Publication
(10) Pub. No.: US 2021/0253170 A1
(43) Pub. Date: Aug. 19, 2021

(54) TRAVELING UNIT, NON-TRANSITORY STORAGE MEDIUM, AND SYSTEM

(71) Applicant: TOYOTA JIDOSHA KABUSHIKI KAISHA, Toyota-shi (JP)

(72) Inventors: Tatsuya MATSUNAMI, Nisshin-shi (JP); Atsuko YAMANAKA, Toyota-shi (JP); Kunihiro TSUNEKAWA, Toyota-shi (JP); Sokfan YEE, Toyota-shi (JP); Masahiro TANAKA, Toyota-shi (JP); Shuichiro TAKAHASHI, Okazaki-shi (JP); Satoshi NONOYAMA, Toyota-shi (JP); Tokuyuki NISHIKAWA, Toyota-shi (JP); Hikaru SATOU, Okazaki-shi (JP)

(73) Assignee: TOYOTA JIDOSHA KABUSHIKI KAISHA, Toyota-shi (JP)

(21) Appl. No.: 17/176,462

(22) Filed: Feb. 16, 2021

(30) Foreign Application Priority Data
Feb. 14, 2020 (JP) 2020-023327

(51) Int. Cl. B62D 21/14; B60B 35/10

(52) U.S. Cl. CPC B62D 21/14; B60B 35/10

(57) ABSTRACT

The present disclosure encourages utilization of a traveling unit to which a connectable unit can be connected on an upper side in a separable manner. A controller of the traveling unit to which the connectable unit can be connected on the upper side in a separable manner of the present disclosure executes changing a form of the traveling unit so that the traveling unit in a separated state where the connectable unit is separated takes a different form from a form in a connection state where the connectable unit is connected, and controlling travel of the traveling unit in accordance with the form of the traveling unit.

### CROSS REFERENCE TO THE RELATED APPLICATION

This application claims the benefit of Japanese Patent Application No. 2020-023327, filed on Feb. 14, 2020, which is hereby incorporated by reference herein in its entirety.

### BACKGROUND

### Technical Field

The present disclosure relates to a traveling unit, a non-transitory storage medium, and a system.

### Description of the Related Art

Patent document 1 discloses a vehicle width changing apparatus which is changeable in a longitudinal width and a transverse width of a vehicle. This vehicle width changing apparatus includes a first axle to which tires are connected at both ends, a second axle to which tires are connected at both ends, the second axle being provided such that the second axle intersects with the first axle and rotatable in a horizontal plane with respect to the first axle, and an axle crossing angle adjusting unit that adjusts an angle at which the first axle intersects with the second axle.

### CITATION LIST

### Patent Document

[Patent document 1] Japanese Patent Laid-Open No. 2017-178305

### SUMMARY

One or more aspects of the present disclosure are directed to encourage utilization of a traveling unit to which a connectable unit can be connected on an upper side in a separable manner.

One aspect of an embodiment of the present disclosure may be exemplified by a traveling unit including a controller comprising at least one processor. This traveling unit may allow a connectable unit to be connected on an upper side in a separable manner, and the controller may execute changing a form of the traveling unit so that the traveling unit in a separated state where the connectable unit is separated may take a different form from a form in a connection state where the connectable unit is connected, and controlling travel of the traveling unit in accordance with the form of the traveling unit. Another aspect of the embodiment of the present disclosure may be also exemplified by a non-transitory storage medium that stores a program for causing the controller to perform execution. Still another aspect of the embodiment of the present disclosure may be also exemplified by a system including the traveling unit and a server apparatus which can perform communication with the traveling unit.

According to the present traveling unit, it becomes possible to encourage utilization of the traveling unit.

### BRIEF DESCRIPTION OF THE DRAWINGS

FIG. 1 is a conceptual diagram of a traveling unit to which a connectable unit is connected, according to an embodiment of the present disclosure.

FIG. 2A and FIG. 2B are conceptual diagrams of the traveling unit in FIG. 1 and is a view in a separated state where the connectable unit is separated.

FIG. 3A, FIG. 3B and FIG. 3C are views illustrating a transformed form of the traveling unit in FIG. 2.

FIG. 4 is a block diagram schematically illustrating a configuration in a system according to the embodiment of the present disclosure and is a view particularly illustrating a configuration of the traveling unit in FIG. 1.

FIG. 5 is a block diagram schematically illustrating a configuration in the system in FIG. 4 and is a view particularly illustrating a configuration of a server apparatus.

FIG. 6 is a flowchart of control at the traveling unit. FIG. 7 is a flowchart of control at the server apparatus.

### DESCRIPTION OF THE EMBODIMENTS

In the present embodiment, a traveling unit including a controller will be described as an example. To this traveling unit, a connectable unit can be connected on an upper side in a separable manner. The control unit executes changing a form of the traveling unit so that the traveling unit in a separated state where the connectable unit is separated takes a different foim from a foim in a connection state where the connectable unit is connected, and controlling travel of the traveling unit in accordance with the form of the traveling unit.

The traveling unit allows the connectable unit to be connected on the upper side in a separable manner. When the traveling unit is in the separated state where the connectable unit is separated, the control unit of the traveling unit changes the form of the traveling unit so that the traveling unit at that time takes a different form from the form in the connection state where the connectable unit is connected. The changing the form of the traveling unit preferably includes making a horizontal occupied region of the traveling unit narrower in the separated state where the connectable unit is separated than in the connection state where the connectable unit is connected. In addition to or in place of this, the changing the form of the traveling unit preferably includes making a height of the traveling unit higher in the separated state where the connectable unit is separated than in the connection state where the connectable unit is connected. Then, the control unit of the traveling unit controls travel of the traveling unit in accordance with the form of the traveling unit. For example, a steering angle, a radius of rotation, or the like, of wheels are changed in accordance with the form of the traveling unit. Through such processing, it becomes possible to realize preferred travel while changing the form of the traveling unit in accordance with, for example, a situation. Therefore, it becomes possible to encourage utilization of the traveling unit.

The traveling unit according to the embodiment of the present disclosure, information processing at the control unit at the traveling unit, a non-transitory storage medium, and a system including the traveling unit will be described below with reference to the drawings.

A system S according to the embodiment of the present disclosure includes traveling units 100 (100A, . . . ) and a server apparatus 200. Here, the traveling unit 100 is a mobile body which can travel on the basis of an operation command from the server apparatus 200. The server apparatus 200 is an information processing apparatus and a computer on a network N. The server apparatus 200 is configured to be able to perform communication with each of the traveling units 100 via the network N and coordinates with information processing apparatuses 102 of the traveling units 100 via the network N. Note that there may be any number of one or more traveling units 100 (100A, . . . ) in the system S.

The server apparatus 200 can also perform communication with other server apparatuses, or the like, via the network N. The server apparatus 200 is configured to be able to perform communication also with each of user apparatuses 300 (300A, . . . ) via the network N as well as being configured to be able to perform communication with each of the traveling units 100.

Here, the user apparatuses 300 are configured to be able to perform communication also with the traveling units 100 via the network N as well as being configured to be able to perform communication with the server apparatus 200 via the network N. The user apparatuses 300 are preferably associated with users. The user apparatuses 300 are, for example, mobile phones, smartphones, personal computers, or the like. Note that there may be any number of one or more user apparatuses 300 (300A, . . . ).

The traveling unit 100, which is one type of autonomous traveling vehicles here, is also called an Electric Vehicle (EV) palette. The traveling unit 100 is configured as a mobile body which can autonomously travel and can travel in an unmanned state. In the system S, the traveling unit 100 can employ various dimensions and various configurations. Further, the traveling unit 100 does not necessarily have to be a vehicle which can completely autonomously travel. For example, the traveling unit 100 may be a vehicle which is driven by a person or which supports driving in accordance with a situation.

The server apparatus 200 is, here, for example, an apparatus which issues a command of operation to the traveling unit 100. For example, the server apparatus 200 provides, that is, transmits an operation command including a travel plan of the traveling unit 100 to the traveling unit 100.

Respective components in the system S will be described in detail below. First, the traveling unit 100 will be described.

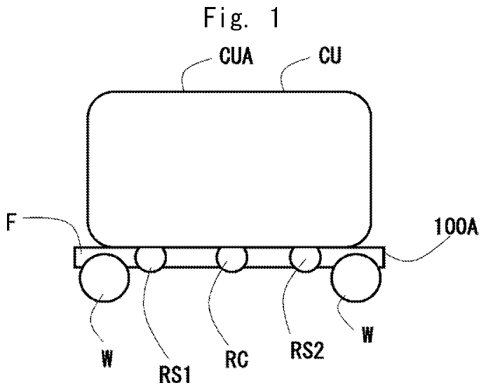

A plurality of traveling units 100 has the same connection structure, and each of the traveling units 100 can be connected to various kinds of units to be connected CU (CUA, . . . ) which will be described below. The traveling unit 100 is configured to be able to travel alone and is configured so that the connectable unit CU is connected so as to be able to be disconnected, that is, separated. FIG. 1 illustrates a state where the connectable unit CUA as an example is placed on an upper side of the traveling unit 100A among the traveling units 100 and is connected in a separable manner.

The connectable unit CU includes, for example, internal space and a door which connects the internal space to outside and is configured to be able to be utilized as, for example, a mobile shop, transportation of baggage, or the like. Further, the connectable unit CU may be configured so that a person can get on board. While a plurality of units to be connected CU can has various sizes and configurations, the units to be connected CU have the same connection structure and can be connected to the same traveling unit 100.

The traveling units 100 to which the units to be connected CU are connected in a separable manner in this manner will be described using an example of the traveling unit 100A among them. Other traveling units 100 (100B, ...) employ a configuration of the traveling unit 100A in a similar manner.

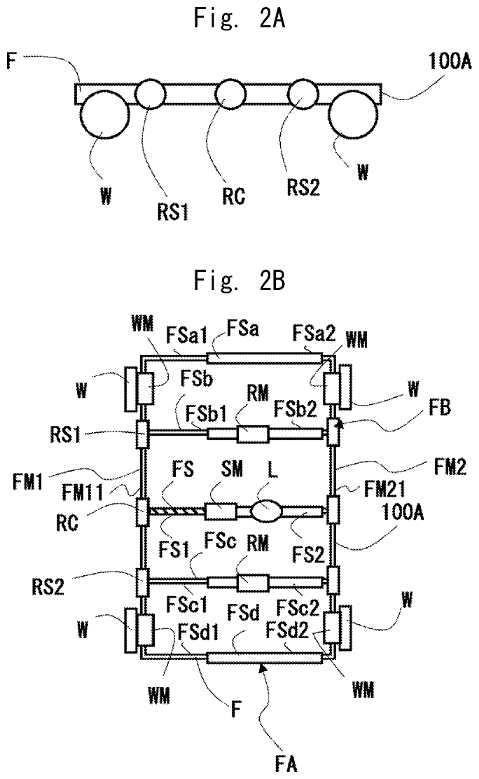

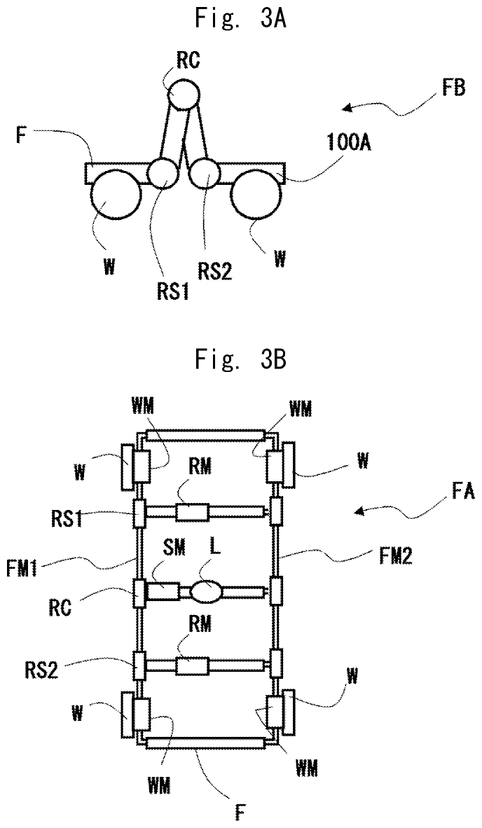

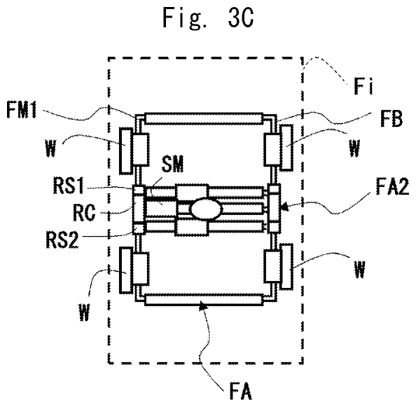

The traveling unit 100A from which the connectable unit CUA is separated from a state in FIG. 1 are illustrated in FIG. 2A and FIG. 2B. Because, as illustrated in FIG. 1, the units to be connected CU can be connected to the traveling unit 100A illustrated in FIG. 2A and FIG. 2B, here, a form of the state in FIG. 2A and FIG. 2B will be referred to as a “connectable state”. FIG. 2A is a side view of the traveling unit 100A in the connectable state, and FIG. 2B is a top view of the traveling unit 100A. FIG. 2 illustrates part of a mechanism for changing the form and a traveling mechanism in the traveling unit 100A. Further, FIG. 3A, FIG. 3B and FIG. 3C respectively illustrate the traveling unit 100A in the separated state. Here, the “separated state” indicates a state of the traveling unit where the connectable unit CU is separated and includes the “connectable state”.

The traveling unit 100A includes a frame F which supports the whole of the traveling unit 100A as a framework of the traveling unit 100A, and which supports the placed connectable unit CUA from underneath, and wheels W provided at the frame F. While the traveling unit 100A includes four wheels W, the traveling unit 100A may include any number of wheels W, and, specifically, may include three wheels W or five or more wheels W. Here, a motor WM for driving the wheel W is provided at each wheel W.

The traveling unit 100A is configured so that a form of the traveling unit 100A can be transformed and includes a mechanism for changing the form. The traveling unit 100A includes a first transforming mechanism FA and a second transforming mechanism FB. First, the first transforming mechanism FA will be described.

The first transforming mechanism FA of the traveling unit 100A includes the frame F described above which can expand and contract and includes a first frame member FM1 and a second frame member FM2 which have nested relationship. The traveling unit 100A in an extended state where the first frame member FM1 is pulled out from the second frame member FM2 is illustrated in FIG. 2B. Further, the traveling unit 100A in a shortened state where the first frame member FM1 is inserted deepest inside the second frame member FM2 is illustrated in FIG. 3B and FIG. 3C.

The first frame member FM1 is, for example, a component of substantially a left portion (left portion with respect to a vehicle traveling direction) in the drawing in planar view in FIG. 2B. As illustrated in FIG. 2B, the first frame member FM1 includes a left longitudinal frame FM11, a male screw portion FS1 as a frame shaft which extends rightward in a width direction from the left longitudinal frame FM11, and other frame shafts FSa1, FSb1, FSc1 and FSd1. The second frame member FM2 is, for example, a component of substantially a right portion (right portion with respect to the vehicle traveling direction) in the drawing in planar view in FIG. 2B. As illustrated in FIG. 2B, the second frame member FM2 includes a right longitudinal frame FM21, a female screw portion FS2 as a frame shaft which extends leftward in a width direction from the right longitudinal frame FM21, and other frame shafts FSa2, FSb2, FSc2 and FSd2.

The male screw portion FS1 can be screwed into the facing female screw portion FS2. Further, the left frame shafts FSa1, FSb1, FSc1 and FSd1 can respectively slide along guide grooves provided at the facing right frame shafts FSa2, FSb2, FSc2, FSd2. However, the left longitudinal frame FM11 may include a female screw portion, and the right longitudinal frame FM21 may include a male screw. The guide grooves may be provided at the left frame shafts FSa1, FSb1, FSc1 and FSd1, and the facing right frame shafts FSa2, FSb2, FSc2 and FSd2 may be able to slide along the facing guide grooves. Such a structure in which the male screw portion FS1 can be screwed into the female screw portion FS2 will be referred to as a nested structure. Further, a structure in which the left frame shafts FSa1, FSb1, FSc1 and FSd1 and the right frame shafts FSa2, FSb2, FSc2 and FSd2 can slide each other will be referred to as a width-direction nested structure.

As a result of the traveling unit 100A employing the first frame member FM1 and the second frame member FM2 which have this nested structure, a width of the traveling unit 100A can be expanded and contracted. Relative movement between the first frame member FM1 and the second frame member FM2 can be achieved by activating a motor SM for moving the first frame member FM1 with respect to the second frame member FM2. Therefore, at the frame shaft FS which extends in a width direction at substantially the center in a longitudinal direction of the traveling unit 100A at which the motor SM is provided as described above, the male screw portion FS1 of the first frame member FM1 is screwed into the female screw portion FS2 of the second frame member FM2. At each of the frame shafts FSa, FSb, FSc and FSd which extend in the width direction, other than the frame shaft FS in the width direction at the center in the longitudinal direction, a guide groove is formed at one of the first frame member FM1 and the second frame member FM2. Further, a convex portion which is guided along the guide groove is provided at the other of the first frame member FM1 and the second frame member FM2. Note that a position of the motor SM is not limited to the positions in FIG. 2 and FIG. 3 and can be changed to various positions. Further, the traveling unit 100A may employ a configuration similar to the width-direction nested structure so that a length in the longitudinal direction can be expanded and contracted. For example, the traveling unit 100A may have a structure which can be expanded and contracted by one of the left longitudinal frame FM11 and the right longitudinal frame FM21 including a screwable structure, and the other sliding in the guide groove.

As illustrated in FIG. 3, the traveling unit 100A includes the above-described second transforming mechanism FB. The second transforming mechanism FB of the traveling unit 100A is configured so that as well as the length in the longitudinal direction of the traveling unit 100A, a height of the traveling unit 100A can be changed. Particularly, the second transforming mechanism FB is configured as a mechanism for making the height of the traveling unit 100A higher as the horizontal occupied region of the traveling unit 100A becomes narrower. The second transforming mechanism FB of the traveling unit 100A includes rotary joint portions RC, RS1 and RS2. The rotary joint portions RC, RS1 and RS2 are respectively provided at the frame shafts FS, FSb and FSc. The second transforming mechanism FB makes the length in the longitudinal direction of the traveling unit 100A variable by adjusting respective rotational positions of the rotary joint portions RC, RS1 and RS2. The rotary joint portion RC at the center is positioned at the midpoint of the rotary joint portions RS1 and RS2 in the longitudinal direction in the vehicle traveling direction. Motors RM are provided at the rotary joint portions RS1 and RS2 before and after the rotary joint portion RC, that is, at the respective frame shafts FSb and FSc. Therefore, by activating the motor RM at the rotary joint portion RS1 and the motor RM at the rotary joint portion RS2 in synchronization with each other, it is possible to change the form of the traveling unit 100A both in the extended state in FIG. 2A, FIG. 2B and FIG. 3B, and in the shortened state in FIG. 3A and FIG. 3C. Here, synchronization refers to making a rotation angle and a timing of rotation operation of the motor RM at the rotary joint portion RS1 match a rotation angle and a timing of rotation operation of the motor RM at the rotary joint portion RS2 within an allowable range of error. However, a drive mechanism of the motor RM, or the like, may be provided only at the rotary joint portion RC at the center, or may be provided at all the rotary joint portions RC, RS1 and RS2. Note that a position of the motor RM is not limited to the positions in FIG. 2 and FIG. 3 and can be changed to various positions.

FIG. 3A is a side view of the traveling unit 100. FIG. 3A illustrates the traveling unit 100A which is shortened in the longitudinal direction of the traveling unit 100 by the second transforming mechanism FB. FIG. 3B illustrates the traveling unit 100A which is shortened in the width direction of the traveling unit 100 by the first transforming mechanism FA. FIG. 3C illustrates the traveling unit 100A which is shortened by the first transforming mechanism FA and the second transforming mechanism FB. In FIG. 3C, a virtual line Fi corresponding to the frame F in the state in FIG. 2B is indicated for comparison. By driving the first transforming mechanism FA and/or the second transforming mechanism FB, it is possible to make a projected area on a horizontal plane of the traveling unit 100A, in other words, the horizontal occupied region variable. In other words, the changing the form of the traveling unit 100A includes making the horizontal occupied region of the traveling unit 100A narrower in the separated state where the connectable unit CU is separated than in the connection state where the connectable unit CU is connected. This point has been already described on the basis of FIG. 1 to FIG. 3. Further, as can be clear from comparison with FIG. 2A and FIG. 3A, the changing the form of the traveling unit 100A includes making the height of the traveling unit 100A higher in the separated state where the connectable unit CU is separated than in the connection state where the connectable unit CU is connected.

Note that, in the traveling unit 100A in the state of FIG. 3A or FIG. 3C, a light L is provided at the frame shaft FS of the frame F located at an upper portion. Here, when the traveling unit 100A is in the state of FIG. 3A or FIG. 3C, the light L is lighted. Therefore, even in a state where the connectable unit CU is not connected, existence of the traveling unit 100A can be recognized from the circumference more easily.

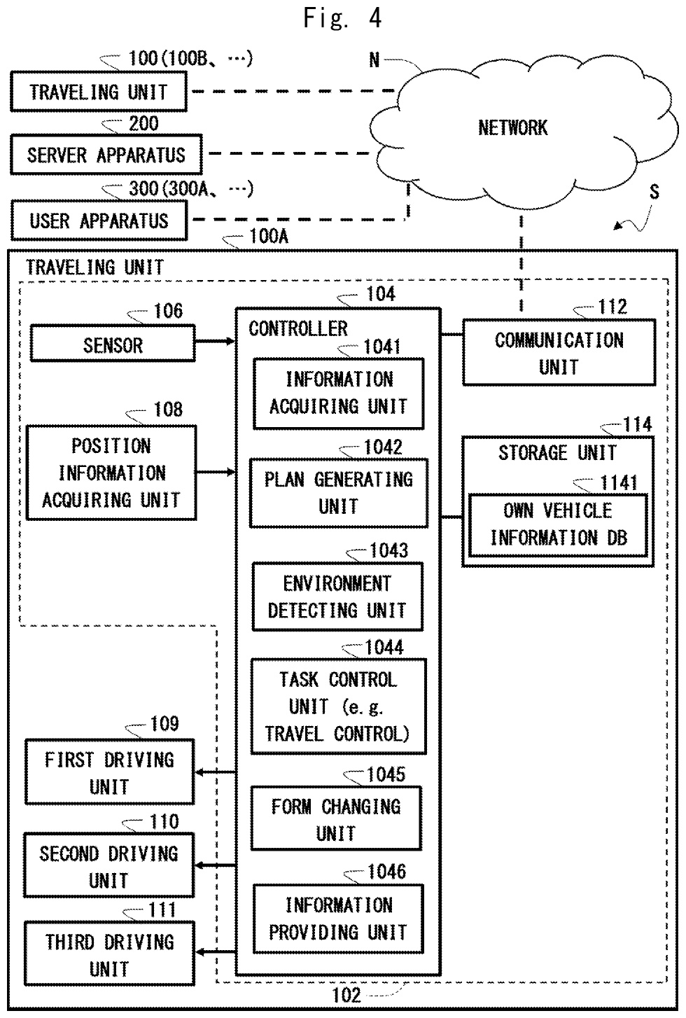

By the way, FIG. 4 is a block diagram schematically illustrating a configuration of the system S including the traveling units 100, the server apparatus 200 and the user apparatuses 300, and, particularly, is a view illustrating a configuration of the traveling unit loaA. FIG. 4 illustrates the configuration of the traveling unit 100A as an example of the traveling units 100, and, particularly, illustrates a configuration of a control system. Other traveling units 100 (100B, . . . ) also include components which will be described below, for example, an information processing apparatus 102 in a similar manner.

The traveling unit 100A in FIG. 2 includes the information processing apparatus 102 and includes a controller 104 which practically pertains the functions. The traveling unit 100A can travel, or the like, in accordance with an operation command acquired from the server apparatus 200. Specifically, the traveling unit 100A travels using an appropriate method while sensing the circumference of the vehicle on the basis of the operation command acquired via the network N.

The traveling unit 100A further includes a sensor 106, a position information acquiring unit 108, a first driving unit 109, a second driving unit 110, a third driving unit 111, a communication unit 112, and a storage unit 114. The traveling unit 100A operates with power supplied from a battery.

The sensor 106, which is means for sensing the circumference of the vehicle, typically includes a stereo camera, a laser scanner, a Light Detection and Ranging, Laser Imaging Detection and Ranging (LIDAR), a radar, or the like. The information acquired by the sensor 106 is transmitted to the controller 104. The sensor 106 includes a sensor to be used by the own vehicle to autonomously travel. The sensor 106 includes a camera provided at a vehicle body of the traveling unit 100A. For example, the camera can be an imaging apparatus which uses an image sensor such as Charged-Coupled Devices (CCD), a Metal-Oxide-Semiconductor (MOS) or a Complementary Metal-Oxide-Semiconductor (CMOS).

The position information acquiring unit 108 is means for acquiring a current position of the traveling unit 100A. The position information acquiring unit 108 includes a Global Positioning System (GPS) receiver, or the like. The GPS receiver as a satellite signal receiver receives signals from a plurality of GPS satellites. Each GPS satellite is an artificial satellite which orbits the earth. A satellite positioning system, that is, a Navigation Satellite System (NSS) is not limited to the GPS. The position information may be detected on the basis of signals from various satellite positioning systems. The NSS is not limited to a global navigation satellite system, and can include a Quasi-Zenith Satellite system, and can include, for example, “Galileo” in Europe or “Michibiki” in Japan which is operated integrally with the GPS. Note that the position information acquiring unit 108 may include a receiver which receives radio waves from a transmitter such as, for example, a beacon. In this case, preferably, a plurality of transmitters is provided at sides of roads, or the like, and regularly transmit radio waves in specific frequencies and/or signal forms. Note that a position information detection system including the position information acquiring unit 108 is not limited to these techniques.

The controller 104 is a computer which controls the traveling unit 100A on the basis of the information acquired from the sensor 106, the position information acquiring unit 108, or the like. The controller 104 is an example of control means for controlling travel of the traveling unit 100A, work of connecting and separating the connectable unit CU to and from the traveling unit, or the like.

The controller 104 includes a CPU and a main storage unit and executes information processing by programs. The CPU is also referred to as a processor. The main storage unit of the controller 104 is an example of a main memory. The CPU at the controller 104 provides various kinds of functions by executing computer programs which are deployed to the main storage unit so as to be able to be executed. The main storage unit at the controller 104 stores computer programs to be executed by the CPU and/or data, or the like. The main storage unit at the controller 104 is a Dynamic Random Access Memory (DRAM), a Static Random Access Memory (SRAM), a Read Only Memory (ROM), or the like.

The controller 104 is connected to the storage unit 114. The storage unit 114, which is a so-called external storage unit, is used as a storage area which supplements the main storage unit of the controller 104, and stores computer programs to be executed by the CPU of the controller 104 and/or data, or the like. The storage unit 114 is a hard disk drive, a Solid State drive (SSD), or the like.

The controller 104 includes an information acquiring unit 1041, a plan generating unit 1042, an environment detecting unit 1043, a task controller 1044, a form changing unit 1045 and an information providing unit 1046 as functional modules. The respective functional modules are realized by the programs stored in the main storage unit and/or the storage unit 114 being executed by the controller 104, that is, the CPU in the control unit 104.

The information acquiring unit 1041 acquires information such as an operation command including a travel plan from the server apparatus 200. The operation command can include information regarding connection and separation of the connectable unit CU to and from the traveling unit 100A. Further, the information acquiring unit 1041 regularly or irregularly acquires information of the own vehicle and stores the information in an own vehicle information database 1141 of the storage unit 114. The information of the own vehicle includes information regarding a form of the traveling unit 100A (see, for example, FIG. 2 and FIG. 3). Further, the information acquiring unit 1041 acquires a road situation, or the like, via the network N, or the like, and transmits the road situation, or the like, to the form changing unit 1045, or the like.

The plan generating unit 1042 generates an operation plan of the own vehicle on the basis of the operation command acquired from the server apparatus 200, particularly, on the basis of information of the travel plan included in the operation command. Note that the operation plan generated by the plan generating unit 1042 is transmitted to the task control unit 1044 which will be described later. In the present embodiment, the operation plan is data which specifies a route through which the traveling unit 100A is to travel, scheduled date and time at each point on the route, and processing to be performed by the traveling unit 100A at part or the whole of the route.

The environment detecting unit 1043 detects an environment around the vehicle on the basis of the data acquired by the sensor 106. While detection targets are, for example, the number and positions of lanes, the number and positions of vehicles existing around the own vehicle, the number and positions of obstacles (such as, for example, pedestrians, bicycles, structures and buildings) existing around the own vehicle, structures of roads, road signs, or the like, the detection targets are not limited to these. The detection targets may be any object which is required for autonomous travel. Further, the environment detecting unit 1043 may track the detected object. For example, relative speed of the object may be obtained from a difference between a coordinate of an object detected one step before and a coordinate of a current object. Data regarding an environment (hereinafter, environment data) detected by the environment detecting unit 1043 is transmitted to the task control unit 1044 which will be described later.

The task control unit 1044 controls activation of the first driving unit 109 and the second driving unit 110 of the own vehicle on the basis of the operation plan generated by the plan generating unit 1042, the environment data generated by the environment detecting unit 1043 and the position information of the own vehicle acquired by the position information acquiring unit 108. For example, the task controller 1044 causes the own vehicle to travel along a predetermined route and travel so that an obstacle does not enter a predetermined safe region centering around the own vehicle. A publicly known method can be employed as a method for causing a vehicle to autonomously travel. Note that, in this autonomous driving control of the traveling unit 100A, travel of the traveling unit 100A is controlled in accordance with a form of the traveling unit 100A. Therefore, the task controller 1044 acquires information of the form of the traveling unit 100A changed by the form changing unit 1045 through transmission from the form changing unit 1045. Note that this information of the foim may be acquired via the own vehicle information database 1141. Further, the task controller 1044 also executes tasks other than travel on the basis of the operation plan generated by the plan generating unit 1042. Examples of the tasks can include work of connecting and/or separating a vehicle interior unit U.

The form changing unit 1045 changes the form of the traveling unit 100A between the connection state where the connectable unit CU is connected to the traveling unit 100A and the separated state where the connectable unit CU is separated from the traveling unit loaA. Further, in the separated state where the connectable unit CU is separated from the traveling unit 100A, the form changing unit 1045 further changes the form of the traveling unit 100A in accordance with the situation. Specifically, the form changing unit 1045 controls activation of a third driving unit 111 of the own vehicle. At a predetermined time (a predetermined time before connection) at which the connectable unit CU is connected, the form changing unit 1045 changes the form of the traveling unit 100 to a first form of the connectable state illustrated in FIG. 2. Further, in a normal separated state which is not the predetermined time before connection, the form changing unit 1045 changes the form of the traveling unit 100 to a form illustrated in FIG. 3A, that is, a second form in which only the length in the longitudinal direction of the vehicle is shortened. Then, when the traveling unit 100 is in the separated state and predetermined contraction conditions are satisfied, the form changing unit 1045 changes the form of the traveling unit 100 to a form illustrated in FIG. 3C, that is, a third form in which both the length in the longitudinal direction and the width of the vehicle are shortened. Examples of the predetermined contraction conditions can include, for example, acquisition of information indicating that there is a traffic jam among road situations to be acquired via the information acquiring unit 1041. For example, when there is a traffic jam on the road, the width and the length in the longitudinal direction of the traveling unit 100A in the separated state are respectively shortened as illustrated in FIG. 3C. Note that such selection of a form in each scene is not limited to the present embodiment.

The information providing unit 1046 provides information of the own vehicle, for example, the information stored in the own vehicle information database 1141 to the server apparatus 200. Here, provision of the information refers to transmission of the information. This provision may be regularly performed or irregularly performed.

The first driving unit 109 is means for causing the traveling unit 100A to travel on the basis of the command generated by the task controller 1044. The first driving unit 109 includes, for example, a motor WM for driving the wheels W, an inverter, a brake, a steering mechanism, a secondary cell, or the like.

The second driving unit 110 is means for causing each work of connecting and/or separating the connectable unit CU to be performed on the basis of the command generated by the task controller 1044. The second driving unit 110 includes a hydraulic mechanism or a motor for activating a connection mechanism, or the like.

The third driving unit 111 is means for activating a mechanism for changing the form including the above-described first transforming mechanism FA and the above-described second transforming mechanism FB in accordance with the connection state and the separated state of the connectable unit CU on the basis of the command generated by the foil changing unit 1045. The third driving unit 111 includes a motor SM of the first transforming mechanism FA and a motor RM of the second transforming mechanism FB.

The communication unit 112 includes communication means for connecting the traveling unit 100A to the network N. In the present embodiment, the traveling unit 100A can perform communication with other apparatuses, for example, the server apparatus 200 via the network N. The traveling unit 100A can also perform communication with the user apparatus 300 via the network N. Note that the communication unit 112 further includes communication means for allowing the traveling unit 100A which is the own vehicle to pertain inter-vehicle communication with other traveling units 100 (100B, . . . ).

The server apparatus 200 will be described next. The server apparatus 200 is an apparatus which provides information of various operation commands to each of the plurality of traveling units 100.

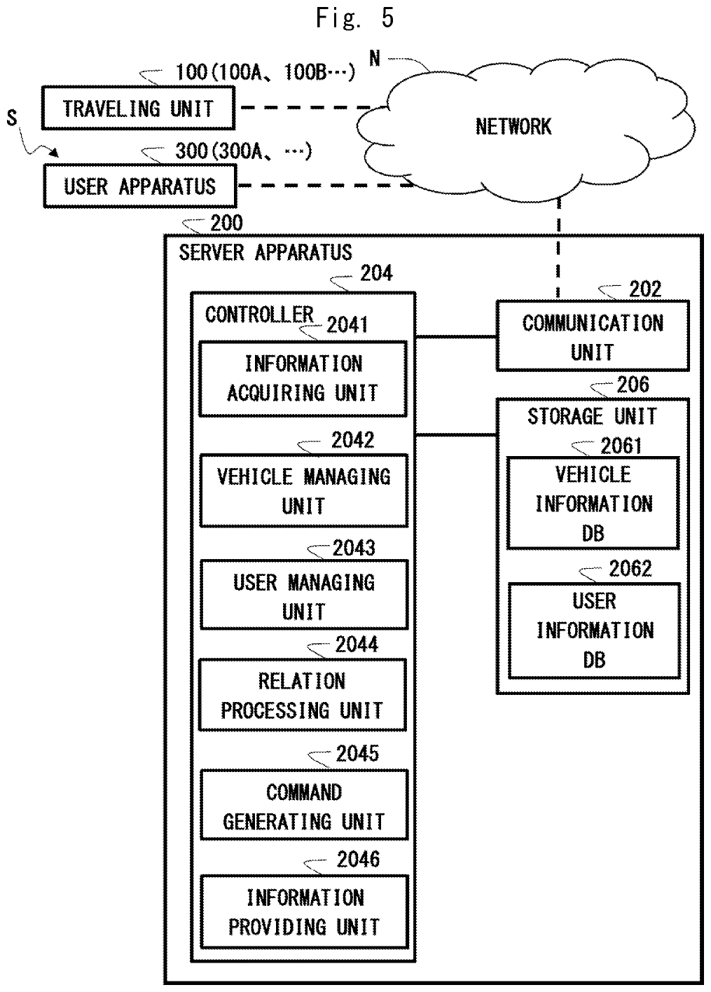

The server apparatus 200, which is an information processing apparatus, as illustrated in FIG. 5, includes a communication unit 202, a controller 204, and a storage unit 206. The communication unit 202 is similar to the communication unit 112, and has a communication function for connecting the server apparatus 200 to the network N. Further, the communication unit 202 of the server apparatus 200 is a communication interface for performing communication with the traveling unit 100 and the user apparatuses 300 via the network N. The controller 204 includes a CPU and a main storage unit in a similar manner to the controller 104 and executes information processing by programs. Of course, this CPU is a processor and the main storage unit of the controller 204 is also an example of a main memory. The CPU at the controller 204 provides various kinds of functions by executing computer programs which are deployed to the main storage unit so as to be able to be executed. The main storage unit at the controller 204 stores computer programs to be executed by the CPU and/or data, or the like. The main storage unit at the controller 204 is a DRAM, an SRAM, a ROM, or the like.

The controller 204 is connected to the storage unit 206. The storage unit 206, which is an external storage unit, is used as a storage area which supplements the main storage unit of the controller 204, and stores computer programs to be executed by the CPU of the controller 204 and/or data, or the like. The storage unit 206 is a hard disk drive, an SSD, or the like.

The controller 204 is means for managing control of the server apparatus 200. As illustrated in FIG. 5, the controller 204 includes an information acquiring unit 2041, a vehicle managing unit 2042, a user managing unit 2043, a relation processing unit 2044, a command generating unit 2045 and an information providing unit 2046 as functional modules. These respective functional modules are realized by programs stored in the main storage unit and/or the storage unit 206 being executed by the CPU of the controller 204.

The information acquiring unit 2041 acquires various kinds of information from the traveling units 100 and the user apparatuses 300. Then, the acquired information is transmitted to the vehicle managing unit 2042, the user managing unit 2043, or the like. The information acquiring unit 2041, for example, regularly acquires the position information, information of the own vehicle information database 1141, or the like, from the traveling units 100 and transmits the information to the vehicle managing unit 2042. Further, the information acquiring unit 2041 acquires information of a plurality of registered users or information input from the users from the user apparatuses 300 associated with the users and transmits the information to the user managing unit 2043.

The vehicle managing unit 2042 manages information of the plurality of traveling units 100 which is under control. Specifically, the vehicle managing unit 2042 receives information of data, or the like, regarding the traveling units 100 from the plurality of traveling units 100 via the information acquiring unit 2041, and stores the information in the vehicle information database 2061 of the storage unit 206. As the information regarding the traveling units 100, the position information and the vehicle information are used. The vehicle information is, for example, identifiers of the traveling units 100, information regarding application, types and waiting points, mileage, a current status, or the like. The current status includes a form of the vehicle. Further, the vehicle managing unit 2042 also stores position information and unit information of the units to be connected CU in the vehicle information database 2061 of the storage unit 206. As the position information of the units to be connected CU, information of positions of connection and/or separation to and/or from the traveling units 100 can be used. The unit information of the units to be connected CU can include information regarding application such as availability at shops in addition to a size of internal space, capacity, or the like.

The user managing unit 2043 stores user information in the user information database 2062 of the storage unit 206. When information from the user (for example, information as to desire to utilize the connectable unit CU) is acquired via the information acquiring unit 2041, the user managing unit 2043 stores the information in the user information database 2062. In the user information database 2062, the user information is stored. The user information includes identification information (such as, for example, a user ID and contact information) specific to the user.

The relation processing unit 2044 executes predetermined processing of associating the traveling units 100 in the separated state in which the connectable unit CU is not connected, that is, separated. For example, when a plurality of traveling units 100 moves from a predetermined area to a certain waiting position, efficiency of transportation or travel can be preferably improved also in tams of traffic safety by the traveling units 100 traveling in a line compared to a case where the respective traveling units 100 individually travel. Therefore, in such a case, assuming that predetermined conditions for travel in a line are satisfied, the plurality of traveling units 100 is associated with each other and caused to travel in a line. Travel in a line refers to a state where a plurality of vehicles continues in a traveling direction and travels in coordination with each other. In travel in a line, the vehicles provide and receive information indicating traveling conditions to and from each other, and, for example, operate while automatically adjusting a distance between the vehicles. To realize travel in a line, the operation plan in the vehicle information database 2061 and/or user reservation information in the user information database 2062, or the like, are referred to. Further, to enable a plurality of traveling units 100 to travel in a line, the relation processing unit 2044 transmits information regarding travel in a line to the command generating unit 2045 so that the operation command for travel in a line includes a command for causing these traveling units 100 to perform inter-vehicle communication.

The command generating unit 2045 generates the operation command including a travel plan of the traveling unit 100 on the basis of information as to user desire to utilize the connectable unit CU, or the like, and/or information regarding travel in a line from the relation processing unit 2044. Note that the information as to the user desire to utilize the connectable unit CU, or the like, may be acquired by being read from the user information database 2062. The generated travel plan can include a destination and/or time of arrival at the destination, or the like.

The information providing unit 2046 provides, that is, transmits the operation command including the travel plan generated by the command generating unit 2045 to a predetermined traveling unit 100. Upon this transmission to the traveling unit 100, the vehicle information database 2061 is referred to. Further, the information providing unit 2046 provides travel schedule of the traveling unit 100 and/or arrangement of the connectable unit CU, or the like, to the user apparatus 300 of the user. Upon this provision of the information to the user apparatus 300, the user information database 2062 is referred to.

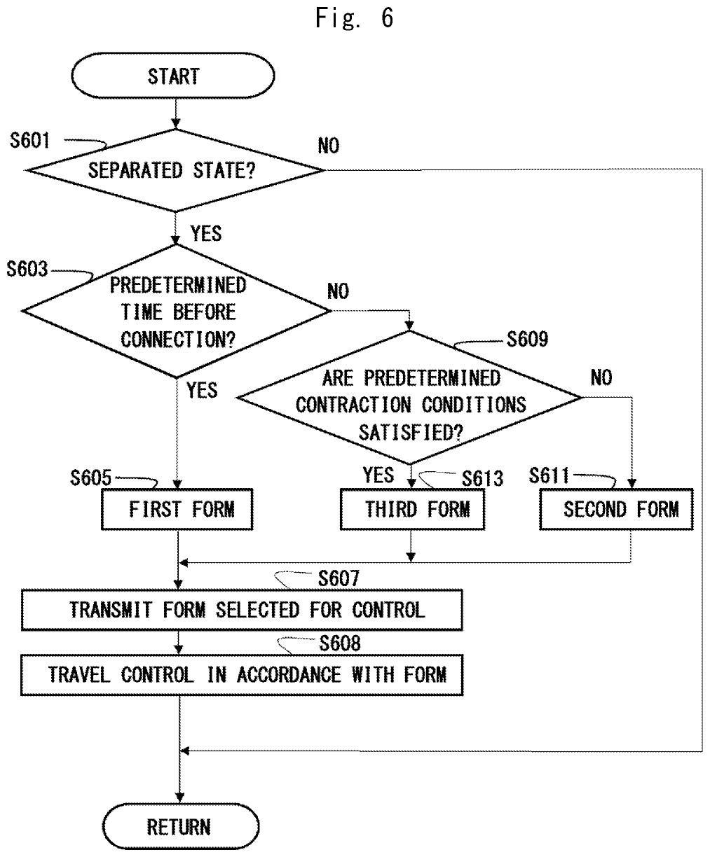

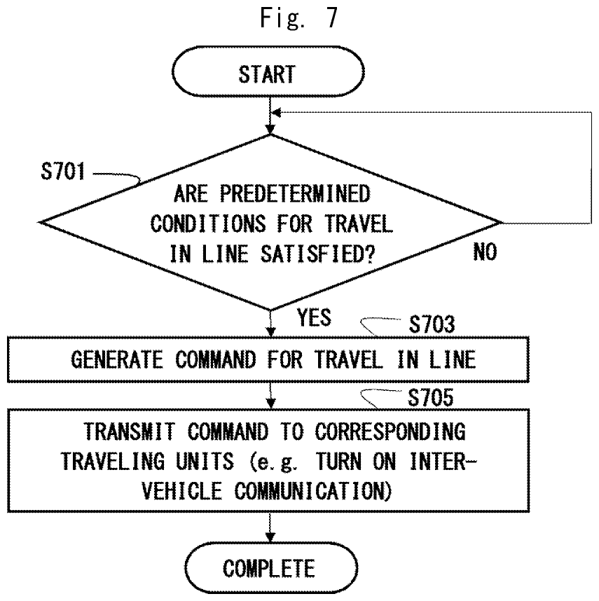

Here, processing in the system S including the above-described configuration will be described. First, change of the foim of the traveling unit 100 and control in accordance with the form will be described on the basis of FIG. 6. Note that change of the form of the traveling unit 100A will be described below with reference to FIG. 1 to FIG. 3.

When the traveling unit 100A is in a state illustrated in FIG. 1, that is, in the connection state where, for example, the connectable unit CUA is connected, the form changing unit 1045 keeps the form of the traveling unit 100A as is (a negative result is obtained in determination in step S601). At this time, the task controller 1044 acquires first control data associated with the connection state from the storage unit 114. Further, the task controller 1044 controls the first driving unit 109 on the basis of this first control data. Control data including the first control data can include a steering angle, a radius of rotation, or the like, of the wheels W and/or data relating to these, or the like.

Meanwhile, when the traveling unit 100A is in the separated state where, for example, the connectable unit CUA is separated, the form changing unit 1045 changes the form of the traveling unit 100A in accordance with a situation (a positive result is obtained in determination in step S601). Specifically, a positive result is obtained in determination in step S603 at a predetermined time (a predetermined time before connection) at which a certain connectable unit CU is connected on the basis of the operation command from the server apparatus 200. At this time, the form changing unit 1045 changes the form of the traveling unit 100A to the first form, that is, the connectable state illustrated in FIG. 2 (step S605). At this time, the form changing unit 1045 controls activation of the third driving unit 111 so as to activate the first transforming mechanism FA and/or the second transforming mechanism FB in a case where the traveling unit 100A has a form other than the first form. Then, the form changing unit 1045 transmits information indicating that the form is the first form to the task controller 1044 (step S607). By this means, as already described above, the task controller 1044 acquires the first control data associated with the first form from the storage unit 114 and controls the first driving unit 109 (step S608).

When the traveling unit 100A is simply in the separated state, a negative result is obtained in the determination in step S603. Then, when the predetermined contraction conditions are not satisfied (a negative result is obtained in determination in step S609), the form changing unit 1045 changes the form of the traveling unit 100A to the second form (step S611). As already described above, while the second form is the same as the first form in expansion and contraction in the width direction of the traveling unit loaA, as illustrated in FIG. 3A, the second form is a form in which only the length in the longitudinal direction is shortened. At this time, the form changing unit 1045 controls activation of the third driving unit 111 so as to activate the first transforming mechanism FA and/or the second transforming mechanism FB in a case where the traveling unit 100A has a form other than the second form. Then, the form changing unit 1045 transmits information indicating that the form is the second form to the task controller 1044 (step S607). By this means, the task controller 1044 acquires second control data associated with the second form from the storage unit 114 and controls the first driving unit 109 (step S608). The second control data can include a steering angle, a radius of rotation, or the like, of the wheels W and/or data relating to these, or the like. The second control data includes, for example, control parameters of autonomous driving, which are changed in accordance with the height of the traveling unit. The second control data is, for example, maximum speed, maximum acceleration, or the like.

A case where the traveling unit 100A is simply in the separated state (a positive result is obtained in the determination in step S601 and a negative result is obtained in the determination in step S603), but the predetermined contraction conditions are satisfied (a positive result is obtained in the determination in step S609) will be described. At this time, the form changing unit 1045 changes the form of the traveling unit 100A to the third form (step S613). The predetermined contraction conditions are, for example, information indicating that there is a traffic jam of a level equal to or higher than a predetermined level. As already described above, the third foim is a form in which the width as well as the length in the longitudinal direction of the traveling unit 100A are shortened as illustrated in FIG. 3C. At this time, the form changing unit 1045 controls activation of the third driving unit 111 so as to activate the first transforming mechanism FA and/or the second transforming mechanism FB in a case where the traveling unit 100A has a form other than the third form. Then, the form changing unit 1045 transmits information indicating that the form is the third form to the task controller 1044 (step S607). By this means, the task controller 1044 acquires third control data associated with the third form from the storage unit 114 and controls the first driving unit 109 (step S608).

The third control data includes control parameters of autonomous driving, which are changed in accordance with a size of the traveling unit 100A. The third control data can include a steering angle, a radius of rotation, or the like, of the wheels W and/or data relating to these, or the like. The third control data is, for example, maximum speed, maximum acceleration, or the like, and when the size of the traveling unit 100A becomes smaller, the maximum speed, the maximum acceleration, or the like, are reduced compared to a case where the size of the traveling unit 100A is a normal size. Further, the third control data is a minimum road width upon search of a route to a destination. When the size of the traveling unit 100A becomes smaller, the minimum road width upon route search is set smaller than that when the size is a normal size. By this means, the traveling unit 100A can travel on a route including a road narrower than that when the size of the traveling unit 100A is the normal size.

Note that the first to the third control data may be respectively stored in either the own vehicle information database 1141 of the storage unit 114 of the traveling unit 100A or other portions.

Travel in a line of the traveling units 100 in the system S will be described next on the basis of FIG. 7. Note that FIG. 7 is a flowchart at the controller 204 of the server apparatus 200.

The relation processing unit 2044 of the controller 204 of the server apparatus 200 determines whether or not the traveling unit 100 which is in the separated state and/or from which the connectable unit is to be separated satisfies the predetermined conditions for travel in a line. The predetermined conditions for travel in a line are determined on the basis of at least one parameter among, for example, density within a predetermined range of the traveling units 100 which is in the separated state or from which the connectable unit is to be separated, a traveling direction, a level of a traffic jam, and a road width. The relation processing unit 2044 searches the vehicle information database 2061 and/or the user information database 2062 for the determination. For example, when the plurality of traveling units 100 moves substantially at the same time from a predetermined area to a certain waiting position, it is determined that the predetermined conditions for travel in a line are satisfied (a positive result is obtained in determination in step S701). By this means, processing of travel in a line is executed at the relation processing unit 2044, and the information is transmitted to the command generating unit 2045.

The command generating unit 2045 of the controller 204 of the server apparatus 200 can acquire identification information of the traveling units 100 which are to be caused to travel in a line, a start position and an end position of travel in a line, and a start time and an end time of travel in a line as information of travel in a line. The command generating unit 2045 generates an operation command including a travel plan for causing the traveling units 100 to travel in a line to all the traveling units 100 which are to be caused to travel in a line (step S703). For example, this travel plan includes the above-described information of travel in a line and can also include information regarding joining at the start position of travel in a line and order of travel in a line.

Then, the information providing unit 2046 of the controller 204 of the server apparatus 200 transmits the generated operation command to all of the traveling units 100 which are to be caused to travel in a line (step S705). Note that this operation command includes a signal which allows the traveling units 100 which are to be caused to travel in a line to perform inter-vehicle communication.

The traveling units 100 which are to be caused to travel in a line acquires the operation command from the server apparatus 200 and executes travel in a line. Note that, here, the form of the traveling unit 100 is changed to the above-described third form upon travel in a line. That is, when the traveling units 100 travel in a line, in step S609 in FIG. 6, it is positively determined that the predetermined contraction conditions are satisfied. The form may be changed to the third form at a time a predetermined period before start of travel in a line, for example, upon joining at a start point of travel in a line. Note that travel in a line is not limited to travel at predetermined intervals. For example, during travel in a line, the plurality of traveling units 100 may be integrated with each other.

In the traveling unit 100 in the above-described system S, the controller 104 executes changing the form of the traveling unit so that the traveling unit in the separated state where the connectable unit CU is separated takes a different form from the form in the connection state where the connectable unit CU is connected. Further, the controller 104 executes controlling travel of the traveling unit in accordance with the form of the traveling unit 100. Therefore, when the traveling unit 100 is in the separated state, it is possible to change the form in accordance with a situation, or the like, so that the travel is preferably performed. Therefore, a use aspect and/or a storage aspect, or the like, of the traveling unit becomes more flexible, so that it is possible to encourage utilization of the traveling unit 100 to which the connectable unit CU can be connected on the upper side in a separable manner.

Further, when the traveling unit 100 is in the separated state where the connectable unit CU is separated, the form of the traveling unit 100 is changed. In the above-described embodiment, the form of the traveling unit 100 in the separated state is changed so that the traveling unit 100 becomes smaller than that in a case where the traveling unit 100 is in the connection state where the connectable unit CU is connected. Therefore, it is possible to realize omission or reduction in size of storage space of the traveling unit 100 and realize relief or alleviation of traffic congestion of the road. Accordingly, it is possible to further encourage utilization of the traveling unit 100 to which the connectable unit CU can be connected on the upper side in a separable manner.

Further, the mechanism for changing the form of the traveling unit 100 is not limited to the mechanism for changing the form of the traveling unit 100 in the above-described embodiment, and various mechanisms for changing the foim can be employed. For example, a mechanism for contracting a pantograph can be employed as the mechanism for changing the form of the traveling unit.

The above-described embodiment is merely an example, and the present disclosure can be modified and implemented as appropriate within a range not deviating from the gist of the present disclosure. The processing and/or the means described in the present disclosure can be implemented while the processing and the means are partially extracted or freely combined unless technical inconsistency arises.

The processing which has been described as being performed by one apparatus may be shared and executed by a plurality of apparatuses. For example, the server apparatus 200 which is an information processing apparatus and/or the information processing apparatus 102 of the traveling unit 100 do not necessarily have to be respectively one computer, and may be configured as a system including a plurality of computers. Alternatively, the processing which has been described as being performed by different apparatuses may be executed by one apparatus. In a computer system, it is possible to flexibly change what kind of hardware configurations implement the respective functions

For example, in the above-described embodiment, as the forms to which the form of the traveling unit 100A is changed, the second form in which only the length in the longitudinal direction of the traveling unit 100A is shortened and the third form in which both the length in the longitudinal direction and the width of the vehicle are shortened have been described as examples. However, the traveling unit 100A of the present embodiment is not limited to these. For example, the form may be transformed to a fourth form (see FIG. 3B) in which a vehicle width is shortened without the length in the longitudinal direction of the traveling unit 100A being changed.

The present disclosure can be implemented by a computer program implementing the functions described in the above-described embodiment being supplied to a computer, and one or more processors of the computer reading out and executing the program. Such a computer program may be provided to the computer with a non-transitory computer-readable storage medium which can be connected to a system bus of the computer or may be provided to the computer via a network. The non-transitory computer-readable storage medium includes, for example, an arbitrary type of disk such as a magnetic disk (such as a floppy (registered trademark) disk and a hard disk drive (HDD)), and an optical disk (such as a CD-ROM, a DVD disk and a blue-ray disk), and an arbitrary type of medium appropriate for storing an electronic command, such as a read only memory (ROM), a random access memory (RAM), an EPROM, an EEPROM, a magnetic card, a flash memory and an optical card.

What is claimed is:

1. A traveling unit to which a connectable unit can be connected on an upper side of the traveling unit in a separable manner, the traveling unit comprising:
a controller comprising at least one processor configured to performs:
changing a form of the traveling unit so that the traveling unit in a separated state where the connectable unit is separated takes a different form from a form in a connected state where the connectable unit is connected; and
controlling travel of the traveling unit in accordance with the form of the traveling unit.

2. The traveling unit according to claim 1,
wherein the changing the form of the traveling unit comprises making a horizontal occupied region of the traveling unit narrower in the separated state where the connectable unit is separated than in the connected state where the connectable unit is connected.

3. The traveling unit according to claim 1,
wherein the changing the form of the traveling unit comprises making a height of the traveling unit higher in the separated state where the connectable unit is separated than in the connection state where the connectable unit is connected.

4. The traveling unit according to claim 1,
wherein the controller executes changing the form of the traveling unit in accordance with at least a road situation.

5. The traveling unit according to claim 1,
wherein the controller executes autonomous driving control of the traveling unit so as to travel in a line with another traveling unit which is in the separated state where a connectable unit of the another traveling unit is separated when the traveling unit is in the separated state where the connectable unit is separated.

6. The traveling unit according to claim 1,
wherein the traveling unit comprises a frame which can expand and contract as a mechanism for changing a form.

7. The traveling unit according to claim 1,
wherein the traveling unit comprises a mechanism for making a height higher as a horizontal occupied region of the traveling unit becomes narrower.

8. A non-transitory storage medium that stores a program for causing a controller comprising at least one processor of a traveling unit to which a connectable unit can be connected on an upper side in a separable manner to execute:
changing a form of the traveling unit so that the traveling unit in a separated state where the connectable unit is separated takes a different form from a form in a connection state where the connectable unit is connected; and
controlling travel of the traveling unit in accordance with the form of the traveling unit.

9. The non-transitory storage medium that stores the program according to claim 8,
wherein the changing the form of the traveling unit comprises making a horizontal occupied region of the traveling unit narrower in the separated state where the connectable unit is separated than in the connection state where the connectable unit is connected.

10. The non-transitory storage medium that stores the program according to claim 8,
wherein the changing the form of the traveling unit comprises making a height of the traveling unit higher in the separated state where the connectable unit is separated than in the connection state where the connectable unit is connected.

11. The non-transitory storage medium that stores the program according to claim 8, for causing the controller to execute:
changing the form of the traveling unit in accordance with at least a road situation.

12. The non-transitory storage medium that stores the program according to claim 8, for causing the controller to execute:
autonomous driving control of the traveling unit so as to travel in a line with another traveling unit which is in the separated state where a connectable unit of the another traveling unit is separated when the traveling unit is in the separated state where the connectable unit is separated.

13. The non-transitory storage medium that stores the program according to claim 8,
wherein the traveling unit comprises a frame which can expand and contract as a mechanism for changing a foim.

14. The non-transitory storage medium that stores the program according to claim 8,
wherein the traveling unit comprises a mechanism for making a height higher as a horizontal occupied region of the traveling unit becomes narrower.

15. A system comprising a traveling unit to which a connectable unit can be connected on an upper side in a separable manner, and a server apparatus which can perform communication with the traveling unit,
the traveling unit comprising a controller comprising at least one processor configured to performs:
changing a form of the traveling unit so that the traveling unit in a separated state where the connectable unit is separated takes a different form from a form in a connection state where the connectable unit is connected; and
controlling travel of the traveling unit on a basis of an operation command acquired from the server apparatus, and
controlling travel of the traveling unit being executed in accordance with the form of the traveling unit.

16. The system according to claim 15,
wherein the changing the form of the traveling unit comprises making a horizontal occupied region of the traveling unit narrower in the separated state where the connectable unit is separated than in the connection state where the connectable unit is connected.

17. The system according to claim 15,
wherein the changing the foim of the traveling unit comprises making a height of the traveling unit higher in the separated state where the connectable unit is separated than in the connection state where the connectable unit is connected.

18. The system according to claim 15,
wherein the controller executes changing the form of the traveling unit in accordance with at least a road situation.

19. The system according to claim 15,
wherein the controller executes autonomous driving control of the traveling unit so as to travel in a line with another traveling unit which is in the separated state where a connectable unit of the another traveling unit is separated when the traveling unit is in the separated state where the connectable unit is separated.

20. The system according to claim 15,
wherein the traveling unit comprises a frame which can expand and contract as a mechanism for changing a form.
